(19) United States
(12) Patent Application Publication
(10) Pub. No.: US 2017/0050412 A1
(43) Pub. Date: Feb. 23, 2017

(54) Reinforcement and Sealing System

(71) Applicant: Zephyros, Inc., Romeo, MI (US)

(72) Inventors: Gary Vanlerberghe, Melvin, MI (US); Craig Langevin, Troy, MI (US)

(21) Appl. No.: 15/240,629

(22) Filed: Aug. 18, 2016

Related U.S. Application Data
(60) Provisional application No. 62/207,641, filed on Aug. 20, 2015.

(51) Int. Cl. B32B 7/12; B32B 27/06; B60J 5/04; B60J 10/80; B60J 10/15; B32B 7/08; B32B 37/12

(52) U.S. Cl. CPC B32B 7/12; B32B 7/08; B32B 27/06; B32B 37/12; B60J 10/80; B60J 10/15; B60J 5/0468; B32B 2605/08

(57) ABSTRACT

A device including a first member comprising a polymeric material, a second member comprising an extruded or pultruded material and having a first terminating end and a second terminating end, and a third member comprising a polymeric material, and a method of making the same.

### TECHNICAL FIELD

The present invention relates generally to a baffling, sealing, or reinforcement member that includes a multi-part interconnected system.

### BACKGROUND

The transportation industry continues to require methods of baffling, reinforcement and sealing that provide improved functionality while simultaneously providing reduced weight and cost. Traditionally, metallic (e.g., steel) reinforcement is utilized in certain locations on transportation vehicles (for example, vehicle doors). However, such reinforcement materials are not only heavy, but many individual structures are needed and these structures each require significant and time consuming installation steps (e.g. welding) during manufacture. As a result, it would be desirable to provide a solution that is lightweight, easily installed and stronger than traditional steel reinforcements.

### SUMMARY OF THE INVENTION

In a first aspect, the present invention contemplates a method comprising: providing a first member, the first member being a molded polymeric member; extruding or pultruding a second member; connecting the first member to the second member, via one or more of an adhesive and a mechanical fastener; and connecting the second member to a third member via one or more of an adhesive, a metallic reinforcement, a mechanical fastener, a friction fit, and a snap fit. The third member may also be a molded polymeric member.

The method may also include locating the connected first, second, and third member into a vehicle cavity after connecting. The method may also include locating the first, second, and third member within a vehicle door. The method may also include locating the second member within a vehicle door adjacent and below a window frame. The method may also include locating the first member within a vehicle door adjacent a first side edge of a window frame. The second member may have a first terminating end and a second terminating end and the first member is connected to the first terminating end and the third member is connected to the second terminating end. The method may also include locating the connected first, second, and third member into a vehicle cavity prior to connecting. The method may also include locating the third member adjacent a second side edge of a window frame. The method may also include connecting one or more of the first, second, or third member with an adjacent member prior to inserting any member into a vehicle cavity and connecting one or more of the first, second, or third member with adjacent member after inserting any member into a vehicle cavity. The first member and third member may comprise one or more of a glass-filled polymeric material, a fiber mat material, an adhesive material, a seal material, and a composite formed of said materials. The second member may comprise one or more of glass fiber, carbon fiber, glass-filled polymer, adhesive material, seal material, and a composite formed of said materials.

The present teachings further provide for a device comprising a first member comprising a polymeric material; a second member comprising an extruded or pultruded material and having a first terminating end and a second terminating end; and a third member comprising a polymeric material. The first member may be connected to the first terminating end of the second member, and the third member may be connected to the second terminating end of the second member. The first member may be connected to the second member via one or more of a mechanical fastener, a mechanical interlock, and an adhesive. The third member may be connected to the second member via one or more of a mechanical fastener, a mechanical interlock, and an adhesive, a metallic reinforcement, a snap fit, and a friction fit. The first member and third member may comprise one or more of a glass-filled polymeric material, a fiber mat material, an adhesive material, a seal material, and a composite formed of said materials. The second member may comprise one or more of glass fiber, carbon fiber, glass-filled polymer, adhesive material, seal material, and a composite formed of said materials.

The invention herein contemplates a device and method for the sealing of cavities with a deformable composite sealing body having one or more fasteners for locating and/or fastening the sealing body within a cavity. The device disclosed herein may allow for effective baffling and/or sealing of a cavity such that the device can be located adjacent to and contact a vehicle panel with minimal or no deformation to the panel.

### DESCRIPTION OF THE DRAWINGS

FIG. 1 shows a perspective view of an illustrative example of the device of the present teachings shown located in a vehicle cavity.

### DETAILED DESCRIPTION

The present teachings meet one or more of the above needs by the improved composite structures and methods described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present invention allows for improved baffling, reinforcement, and sealing of cavities that are typically reinforced with number of welded steel reinforcing sections.

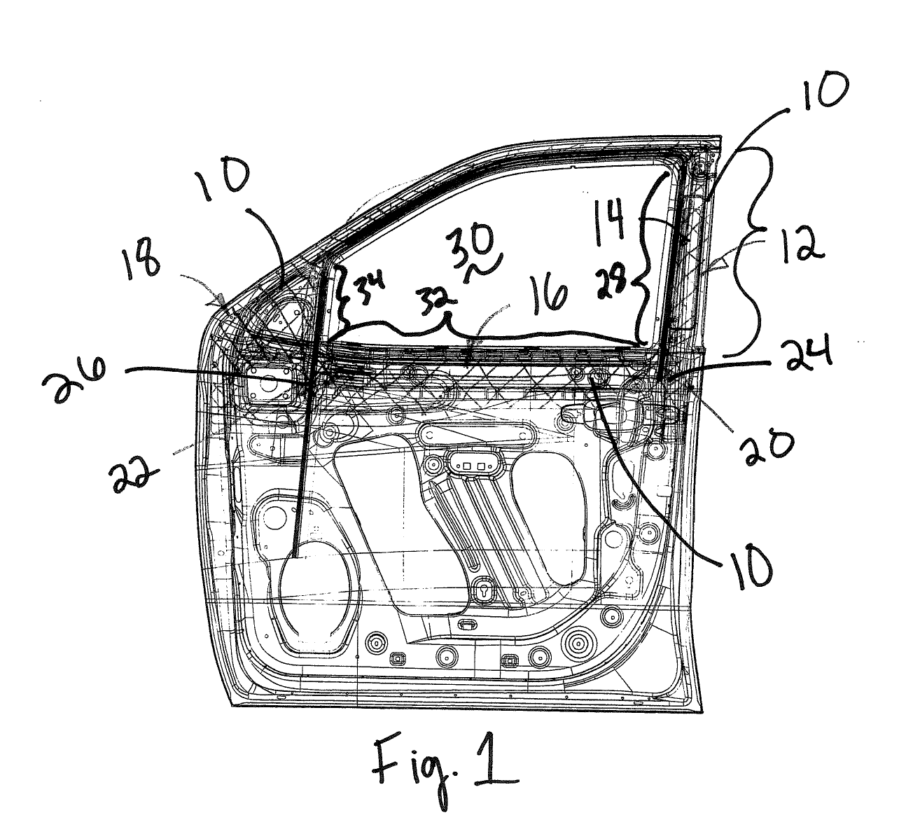

FIG. 1 show the device 10 located in a vehicle door cavity 12. The device 10 includes a first member 14, a second member 16, and a third member 18. The second member 16 includes a first terminating end 20 and a second terminating end 22. The first terminating end 20 connects to the first member 14 via a first fastening means 24. The second terminating end 22 connects to the third member via a second fastening means 26. The first member is shown located adjacent a first side edge 28 of a window frame 30. The second member is shown located adjacent a bottom edge 32 of a window frame 30. The third member is located adjacent a second side edge 34 of a window frame 30.

One or more of the first, second and third members may include an adhesive or seal material that is activatable. For example, the material may be activated to expand upon exposure to a stimulus. The adhesive and/or seal material may be generally dry to the touch or tacky and may be shaped in any form of desired pattern, placement, or thickness, but is preferably of substantially uniform thickness. Such material may be a heat-activated material. An example of a preferred heat activated material is an expandable polymer or plastic, and preferably one that is foamable. The adhesive and/or seal material may be a foam having a polymeric formulation that includes one or more of an epoxy resin, an acetate (e.g. ethylene vinyl acetate), a thermoplastic polyether, an acrylate and/or a methacrylate (e.g., a copolymer of butyl acrylate and methyl acrylate), an epoxy/elastomer adduct, and one or more fillers (e.g., a clay filler, and/or a nanoparticle-containing filler). Preferred thermally expandable materials are disclosed in U.S. Pat. Nos. 7,313,865; 7,125,461; and 7,199,165 incorporated by reference herein for all purposes. For example, and without limitation, the foam may also be an EVA/rubber based material, including an ethylene copolymer or terpolymer that may possess an alpha-olefin. As a copolymer or terpolymer, the polymer is composed of two or three different monomers, i.e., small molecules with high chemical reactivity that are capable of linking up with similar molecules. Suitable expandable materials include those available from L&L Products, Inc. under the designations L7220, L2821, L1066, L205, L2010, L2105, L2108A, L2806, L2811, L4200, L4141, L4161, L4315, L5510, L5520, L5540, L5600, L5601, L7102, and L7104.

A number of baffling or sealing foams may also be used for the seal material. A typical foam includes a polymeric base material, such as one or more ethylene-based polymers which, when compounded with appropriate ingredients (typically a blowing and curing agent), will expand and cure in a reliable and predictable manner upon the application of heat or the occurrence of a particular condition. From a chemical standpoint for a thermally-activated material, the foam is usually initially processed as a flowable material before curing, and upon curing, the material will typically cross-link making the material incapable of further flow.

The adhesive and/or seal material can be formed of other materials provided that the material selected is heat-activated or otherwise activated by an ambient condition (e.g. moisture, pressure, time or the like) and cures under appropriate conditions for the selected application. One such material is the epoxy based resin disclosed in U.S. Pat. No. 6,131,897, the teachings of which are incorporated herein by reference. Some other possible materials include, but are not limited to, polyolefin materials, copolymers and terpolymers with at least one monomer type an alpha-olefin, phenol/formaldehyde materials, phenoxy materials, and polyurethane materials with high glass transition temperatures. Additional materials may also be used such as those disclosed in U.S. Pat. Nos. 5,766,719; 5,755,486; 5,575,526; and 5,932,680, incorporated by reference herein for all purposes.

In applications where the adhesive and/or seal material is a heat activated material, an important consideration involved with the selection and formulation of the material is the temperature at which a material cures and, if expandable, the temperature of expansion. Typically, the material becomes reactive (cures, expands or both) at higher processing temperatures, such as those encountered in an automobile assembly plant, when the material is processed along with the automobile structures at elevated temperatures or at higher applied energy levels, e.g., during coating (e.g., e-coat, paint or clearcoat) curing steps. While temperatures encountered in an automobile assembly operation may be in the range of about 148.89° C. to 204.44° C. (about 300° F. to 400° F.) for body shop applications (e.g., e-coat) and, for paint shop applications, are commonly about 93.33° C. (about 200° F.) or slightly higher (e.g., 120° C.-150° C.).

The first and third members may be connected to the second member via an adhesive, a mechanical fastener, a medical interlock, a metallic reinforcement, or the like. Examples of mechanical fasteners include but are not limited to tree-fasteners or a threaded screw fasteners. The fastener may also be provided in a variety of shapes and in a variety of configurations so long as it can secure one member to another. One example of a suitable fastener is disclosed in U.S. Publication No. 2010/0021267 incorporated by reference herein for all purposes. The fastener may be capable of securing multiple layers or types of materials to one another. Examples of suitable fasteners include mechanical fasteners, clips, tabs, press-fits, snap-fits, screws, hooks, combinations thereof or the like. Furthermore, it is contemplated that the one or more fasteners may be formed integral of a singular material with the material of the first, second, or third member or may be formed of a different material and may be removably attached to the first, second, or third member.

The device of the present invention may be installed into an automotive vehicle although it may be employed for other articles of manufacture such as boats, buildings, furniture, storage containers or the like. The device may be used to seal, reinforce and/or baffle a variety of components of an automotive vehicle including, without limitation, body components (e.g., panels), frame components (e.g., hydroformed tubes), pillar structures (e.g., A, B, C or D-pillars), bumpers, roofs, bulkheads, instrument panels, wheel wells, floor pans, door beams, hem flanges, vehicle beltline applications, doors, door sills, rockers, decklids, hoods or the like of the automotive vehicle.

Formation of the materials of the present invention may include a variety of processing steps depending on the desired configuration of the materials. The device may be formed by a molding process, a pultrusion process, or an extrusion process followed by optional attachment of fasteners. Additional processing and formation steps may not be required. It is generally contemplated one or more layers of materials or one or more different types of materials, including any fasteners and adhesives may be manually attached to each other, automatically attached to each other or a combination thereof. Moreover, various processes such as molding (e.g., compression, injection or other molding), extrusion or the like may be used to form each member individually and such processes may be employed to attach the members together.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “x” parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1: A method comprising:
providing a first member, the first member being a molded polymeric member;
extruding or pultruding a second member;
connecting the first member to the second member, via one or more of an adhesive and a mechanical fastener;
connecting the second member to a third member via one or more of an adhesive, a metallic reinforcement, a mechanical fastener, a friction fit, and a snap fit;
wherein the third member is a molded polymeric member.

2: A method as in claim 1, including locating the connected first, second, and third member into a vehicle cavity after connecting.

3: A method as in claim 1, including locating the first, second, and third member within a vehicle door.

4: A method as in claims 1, including locating the second member within a vehicle door adjacent and below a window frame.

5: A method as in claim 1, including locating the first member within a vehicle door adjacent a first side edge of a window frame.

6: A method as in claim 1, wherein the second member has a first terminating end and a second terminating end and the first member is connected to the first terminating end and the third member is connected to the second terminating end.

7: A method as in claim 1, including locating the connected first, second, and third member into a vehicle cavity prior to connecting.

8: The method as in claim 1, including locating the third member adjacent a second side edge of a window frame.

9: The method as in claim 1, including connecting one or more of the first, second, or third member with an adjacent member prior to inserting any member into a vehicle cavity and connecting one or more of the first, second, or third member with adjacent member after inserting any member into a vehicle cavity.

10: The method as in claim 1, wherein the first member and third member comprise one or more of a glass-filled polymeric material, a fiber mat material, an adhesive material, a seal material and a composite formed of said materials.

11: The method as in claim 1, wherein the second member comprises one or more of glass fiber, carbon fiber, glass-filled polymer, adhesive material, seal material, and a composite formed of said materials.

12: A device comprising:
a first member comprising a polymeric material;
a second member comprising an extruded or pultruded material and having a first terminating end and a second terminating end;
a third member comprising a polymeric material;
wherein the first member is connected to the first terminating end of the second member, and the third member is connected to the second terminating end of the second member.

13: The device of claim 12, wherein the first member is connected to the second member via one or more of a mechanical fastener, a mechanical interlock, and an adhesive.

14: The device of claim 12, wherein the third member is connected to the second member via one or more of a mechanical fastener, a mechanical interlock, and an adhesive, a metallic reinforcement, a snap fit, and a friction fit.

15: The device as in claim 12, wherein the first member and third member comprise one or more of a glass-filled polymeric material, a fiber mat material, an adhesive material, a seal material, and a composite formed of said materials.

16: The device as in claim 12, wherein the second member comprises one or more of glass fiber, carbon fiber, glass-filled polymer, adhesive material, seal material, and a composite formed of said materials.
